(19) United States
(12) Patent Application Publication
(10) Pub. No.: US 2017/0337410 A1
(43) Pub. Date: Nov. 23, 2017

(54) FINGERPRINT SENSING APPARATUS, AN INTEGRATED SENSOR DEVICE, AND A FINGERPRINT SENSING METHOD

(71) Applicant: Novatek Microelectronics Corp., Hsinchu (TW)

(72) Inventors: Shun-Li Wang, Hsinchu City (TW); Hsin-Kuo Chen, Hsinchu County (TW)

(21) Appl. No.: 15/159,821

(22) Filed: May 20, 2016

(51) Int. Cl. G06K 9/00

(52) U.S. Cl. CPC G06K 9/0002; G06K 9/00892

(57) ABSTRACT

A fingerprint sensing apparatus including an integrated sensor device and a fingerprint sensing circuit is provided. The integrated sensor device includes at least two sensors. The integrated sensor device is configured to sense a fingerprint to obtain two different types of information related to the fingerprint. The fingerprint sensing circuit electrically connected to the integrated sensor device. The fingerprint sensing circuit is configured to drive the integrated sensor device to sense the fingerprint. One of the two different types of information is determined according to the other of the two different types of information. In addition, an integrated sensor device and a fingerprint sensing method are also provided.

### BACKGROUND OF THE INVENTION

### 1. Field of the Invention

The invention generally relates to an electrical apparatus, an electrical device and a sensing method, in particular, to a fingerprint sensing apparatus, an integrated sensor device and a fingerprint sensing method.

### 2. Description of Related Art

In the field of mobile device application, due to the demand of user experience is increasing, the design of the mobile device having input elements is more and more important. The input elements may be a touch panel, an accelerometer, a gyroscope, a light sensor, a biometric sensor, and so forth. Especially, the mobile device combined with the biologic sensor has more and more applications. The biological sensor can be used to replace the password unlock or the mobile payment. In addition, the biological sensor can also be used to other applications, such as the image capture function, the motion detection, the click detection, the double-click detection, and so forth. That is to say, the biological sensor may have the ability to replace the pointing device, such as a mouse, a joystick and a trackball.

Moreover, the mobile device integrated with a force sensor is also the currently important application. The force sensor has various forms, such as a mechanical force sensor, a resistive force sensor, a capacitive force sensor, a piezoelectric force sensor, an optical force sensor and so forth. The most important is that the force sensor can be used to detect the physical force, so as to obtain the magnitude of the applied force. Hence, how to design a fingerprint sensing apparatus having above sensors to enhance the user experience is one of the most important topics in the pertinent field.

### SUMMARY OF THE INVENTION

Accordingly, the invention is directed to a fingerprint sensing apparatus, an integrated sensor device, and a fingerprint sensing method, capable of providing a satisfactory user experience.

The invention provides a fingerprint sensing apparatus including an integrated sensor device and a fingerprint sensing circuit. The integrated sensor device includes at least two sensors. The integrated sensor device is configured to sense a fingerprint to obtain two different types of information related to the fingerprint. The fingerprint sensing circuit is electrically connected to the integrated sensor device. The fingerprint sensing circuit is configured to drive the integrated sensor device to sense the fingerprint. One of the two different types of information is determined according to the other of the two different types of information.

In an exemplary embodiment of the invention, the at least two sensors comprise a biometric sensor and a force sensor, and the two different types of information comprise a biological feature and a force value of the fingerprint.

In an exemplary embodiment of the invention, the biometric sensor senses the fingerprint to obtain the biological feature of the fingerprint by biometric sensing pixels thereof.

In an exemplary embodiment of the invention, the force sensor senses the fingerprint to obtain the force value of the fingerprint, and the force sensor is selected from one of a capacitive sensor and a resistive sensor.

In an exemplary embodiment of the invention, the biometric sensor and the force sensor are stacked with each other, and one of the biometric sensor and the force sensor is disposed on the other of the biometric sensor and the force sensor.

In an exemplary embodiment of the invention, if the force value satisfies a predetermined condition, it is determined whether the biological feature is matched with a reference feature.

In an exemplary embodiment of the invention, if the biological feature is identified, it is determined whether the force value satisfies a predetermined condition.

In an exemplary embodiment of the invention, the fingerprint sensing circuit respectively drives the biometric sensor and the force sensor to sense the fingerprint in a manner of time division.

In an exemplary embodiment of the invention, the fingerprint sensing circuit includes a transceiver circuit electrically connected to the biometric sensor and the force sensor. The transceiver circuit receives or transmits the biological feature and the force value during different periods.

In an exemplary embodiment of the invention, the fingerprint sensing circuit further includes a control circuit electrically connected to the transceiver circuit. The control circuit controls the transceiver circuit to receive or transmit the biological feature and the force value during the different periods.

In an exemplary embodiment of the invention, the fingerprint sensing circuit further includes an integrated sensing circuit electrically connected to the transceiver circuit. The integrated sensing circuit includes at least two sensing circuits configured to respectively process the two different types of information, and stores a processed result to a storage apparatus.

The invention provides a fingerprint sensing circuit. The fingerprint sensing circuit is configured to drive an integrated sensor device to sense a fingerprint. The fingerprint sensing circuit includes a transceiver circuit, a control circuit, and an integrated sensing circuit. The transceiver circuit is electrically connected to the integrated sensor device. The transceiver circuit is configured to receive or transmit two different types of information related to the fingerprint. The control circuit is electrically connected to the transceiver circuit. The control circuit is configured to control the transceiver circuit to receive or transmit the two different types of information during different periods. The integrated sensing circuit is electrically connected to the transceiver circuit. The integrated sensing circuit includes at least two sensing circuits configured to respectively process the two different types of information. The integrated sensor device includes at least two sensors configured to sense the fingerprint to obtain the two different types of information. One of the two different types of information is determined according to the other of the two different types of information.

In an exemplary embodiment of the invention, the at least two sensors include a biometric sensor and a force sensor, and the two different types of information include a biological feature and a force value of the fingerprint.

In an exemplary embodiment of the invention, the biometric sensor senses the fingerprint to obtain the biological feature of the fingerprint by biometric sensing pixels thereof.

In an exemplary embodiment of the invention, the force sensor senses the fingerprint to obtain the force value of the fingerprint, and the force sensor is selected from one of a capacitive sensor and a resistive sensor.

In an exemplary embodiment of the invention, the biometric sensor and the force sensor are stacked with each other, and one of the biometric sensor and the force sensor is disposed on the other of the biometric sensor and the force sensor.

In an exemplary embodiment of the invention, if the force value satisfies a predetermined condition, it is determined whether the biological feature is matched with a reference feature.

In an exemplary embodiment of the invention, if the biological feature is identified, it is determined whether the force value satisfies a predetermined condition.

The invention provides a fingerprint sensing method. The fingerprint sensing method is adapted to drive an integrate sensor device to sense a fingerprint. The fingerprint sensing method includes: driving the integrated sensor device to sense the fingerprint to obtain two different types of information related to the fingerprint; and determining one of the two different types of information according to the other of the two different types of information. The integrated sensor includes at least two sensors.

In an exemplary embodiment of the invention, the at least two sensors includes a biometric sensor and a force sensor, and the two different types of information include a biological feature and a force value of the fingerprint.

In an exemplary embodiment of the invention, the step of determining one of the two different types of information according to the other of the two different types of information includes: if the force value satisfies a predetermined condition, determining whether the biological feature is matched with a reference feature.

In an exemplary embodiment of the invention, the step of determining one of the two different types of information according to the other of the two different types of information includes: if the biological feature is identified, determining whether the force value satisfies a predetermined condition.

In an exemplary embodiment of the invention, the step of driving the integrated sensor device to sense the fingerprint to obtain the two different types of information related to the fingerprint includes: respectively driving the biometric sensor and the force sensor to sense the fingerprint in a manner of time division.

According to the above descriptions, in the exemplary embodiments of the invention, for fingerprint sensing, at least two sensors are integrated to obtain two different types of information related to the fingerprint. The fingerprint is identified according to the two different types of information to provide a satisfactory user experience.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a fingerprint sensing apparatus according to an embodiment of the invention.

FIG. 2 is a schematic diagram of an integrated sensor device according to the embodiment of FIG. 1.

FIG. 3A is a schematic diagram of a biometric sensor according to an embodiment of the invention.

FIG. 3B is a schematic diagram of a biometric sensor according to another embodiment of the invention.

FIG. 4A is a schematic diagram of a resistive force sensor according to an embodiment of the invention.

FIG. 4B is a schematic diagram of a resistive force sensor according to another embodiment of the invention.

FIG. 5A and FIG. 5B are schematic diagrams of a capacitive force sensor according to an embodiment of the invention.

FIG. 6 is a schematic diagram of a fingerprint sensing apparatus according to another embodiment of the invention.

FIG. 7 is a flowchart illustrating steps of a fingerprint sensing method according to an embodiment of the invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

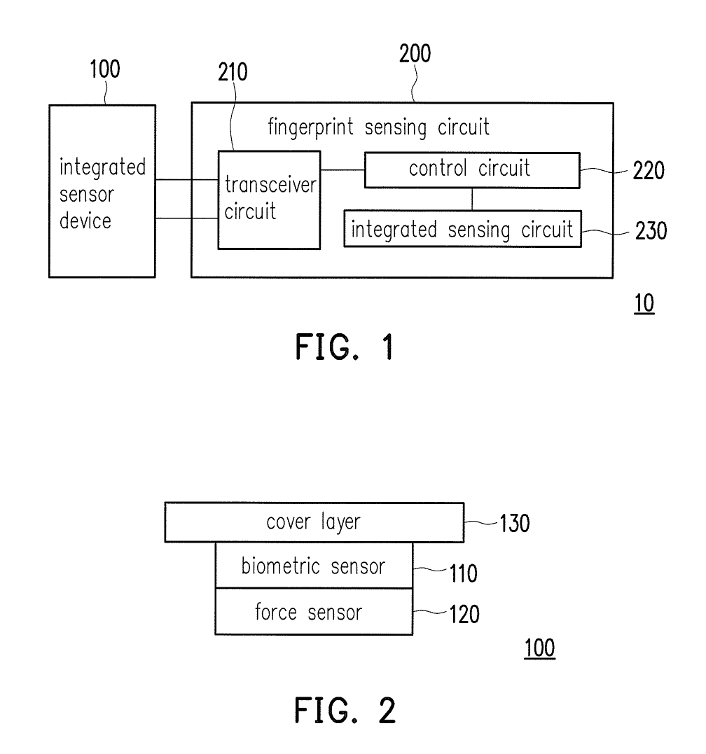

FIG. 1 is a schematic diagram of a fingerprint sensing apparatus according to an embodiment of the invention. Referring to FIG. 1, a fingerprint sensing apparatus 10 of the present embodiment includes an integrated sensor device 100 and a fingerprint sensing circuit 200. The fingerprint sensing circuit 200 is electrically connected to the integrated sensor device 100, and configured to drive the integrated sensor device 100 to sense a fingerprint. In the present embodiment, the fingerprint sensing apparatus 10 may apply to an electrical apparatus having a biometric scanning function, such as a computer, a laptop computer, a smart device, a mobile telephone, a tablet device, or some other appliances that can receive input by touching and interacting with a touch sensitive surface, and the invention is not limited thereto. The integrated sensor 100 may provide a pressing function configured to sense the fingerprint for a user interaction. In the present embodiment, the integrated sensor device 100 includes at least two sensors, and configured to sense the fingerprint to obtain two different types of information related to the fingerprint. In the present embodiment, the fingerprint sensing apparatus 10 may determine one of the two different types of information according to the other of the two different types of information.

In the present embodiment, the fingerprint sensing circuit 200 includes a transceiver circuit 210, a control circuit 220, and an integrated sensing circuit 230. The transceiver circuit 210 is electrically connected to the integrated sensor device 100. The control circuit 220 is electrically connected to the transceiver circuit 210, and may control the transceiver circuit 210 to receive or transmit the two different types of information related to the fingerprint during different periods. Therefore, the fingerprint sensing apparatus 10 may utilize a single fingerprint sensing circuit to drive the integrated sensor device 100. The integrated sensing circuit 230 is electrically connected to the transceiver circuit 210 to process the two different types of information related to the fingerprint.

It should be noticed that, in the present embodiment, the fingerprint sensing apparatus 10 may utilize the control circuit 220 to determine one of the two different types of information according to the other of the two different types of information. In the present embodiment, the control circuit 220 may be a scan logic circuit, a central processing unit (CPU), a chipset, a microprocessor, a controller, an application specific integrated circuit (ASIC), a programmable logic device (PLD), a control circuit, or a combination of aforementioned devices, and the invention is also not limited thereto.

In one embodiment, the fingerprint sensing apparatus 10 may further include another processor circuit (not shown), or electrically connect to an external processor circuit. The fingerprint sensing apparatus 10 may determine one of the two different types of information according to the other of the two different types of information by the foregoing processor circuit. The arrangement of the foregoing processor circuit is not limited in the invention. In the present embodiment, the foregoing processor circuit may be a central processing unit (CPU), a chipset, a microprocessor, a controller, an application specific integrated circuit (ASIC), a programmable logic device (PLD), a control circuit, or a combination of aforementioned devices, and the invention is also not limited thereto.

FIG. 2 is a schematic diagram of an integrated sensor device according to the embodiment of FIG. 1. Referring to FIG. 2, the integrated sensor device 100 of the present embodiment may be a biometric scanner, and may include a biometric sensor 110, a force sensor 120, and a cover layer 130. The biometric sensor 110 and the force sensor 120 are stacked with each other, and one of the biometric sensor 110 and the force sensor 120 is disposed on the other of the biometric sensor 110 and the force sensor 120. In the present embodiment, the biometric sensor 110 is disposed on the force sensor 120, but the invention is not limited thereto. In one embodiment, the force sensor 120 may also be disposed on the biometric sensor 110. In the present embodiment, the cover layer 130 is disposed on the biometric sensor 110 and the force sensor 120, so as to provide a contact surface for the fingerprint. Thereby, the biometric sensor 110 and the force sensor 120 may simultaneously sense the fingerprint through the cover layer 130. The cover layer 130 may be any transparent material for fingerprint sensing. In the present embodiment, the biometric sensor 110 is configured to capture a body-part relief print image, such as fingerprint feature, but the invention is not limited thereto. In one embodiment, the biometric sensor 110 may also be configured to capture other biometric features, such as palm veins, face recognition, DNA, palm print, hand geometry, iris recognition, retina and odour/scent.

For example, the biometric sensor 110 may sense the feature of the fingerprint, and the force sensor may sense a plurality of force values of the fingerprint in a time period. In the present embodiment, the force values may respectively correspond to different features of the fingerprint. That is to say, when the user's finger presses on the biometric sensor 110, the biometric sensor 110 may determine the sensing information including the feature of the fingerprint according to the corresponding force value.

Referring to FIG. 1 and FIG. 2, the fingerprint sensing circuit 200 is electrically connected to the integrated sensor device 100 having the biometric sensor 110 and the force sensor 120, and respectively drive the biometric sensor and the force sensor to sense the fingerprint in a manner of time division. In the present embodiment, the fingerprint sensing apparatus 10 may determine one of the fingerprint feature and the force value according to the other of the fingerprint feature and the force value, and may further generate a feedback or a response according to the force sensing result and the biological sensing result.

For example, in order to enhance the accuracy of the fingerprint identification, when the force value satisfies a predetermined condition, it may be determined whether the biological feature is matched with a reference feature, e.g. a biological feature of a user pre-registered in the integrated sensor device 100. In this case, the predetermined condition may be a threshold value, and the biological feature may be a fingerprint image. To be specific, since the different degrees that the user presses the integrated sensor device 100 may affect the judgement accuracy of the fingerprint image, the fingerprint sensing circuit 200 may determine to obtain a complete finger image when the force value is larger than the threshold value. In other words, the fingerprint sensing circuit 200 may obtain a complete information of the fingerprint according to the judgement condition of the sensing force value. Therefore, the incomplete information of the fingerprint is avoided when the user's finger does not completely press the integrated sensor device 100, or the force value is smaller than the threshold value.

For another example, when the biological feature is identified, it may be determined whether the force value satisfies a predetermined condition, and a feedback or a response to the biological sensing result may be further generated. In this case, the predetermined condition may be a threshold value, and the biological feature may be a user's fingerprint. To be specific, the fingerprint sensing circuit 200 may further include more functions for generating a feedback or a response to the biological sensing result, i.e. the fingerprint. The electrical apparatus having the fingerprint sensing apparatus 10 may provide some interactive operations according to the sensing result, so that the response may be a corresponding function or instruction to interact with the user, but the invention is not limited thereto.

It should be noticed that, in the present embodiment, the fingerprint sensing apparatus 10 not only determines one of the two different types of information according to the other of the two different types of information, but also further generates a feedback or a response according to the force sensing result and the biological sensing result. In addition, in one embodiment, the fingerprint sensing circuit 200 may sense the fingerprint to obtain one type of information related to the fingerprint, and the type of information may be selected from one of the biological feature and the force value.

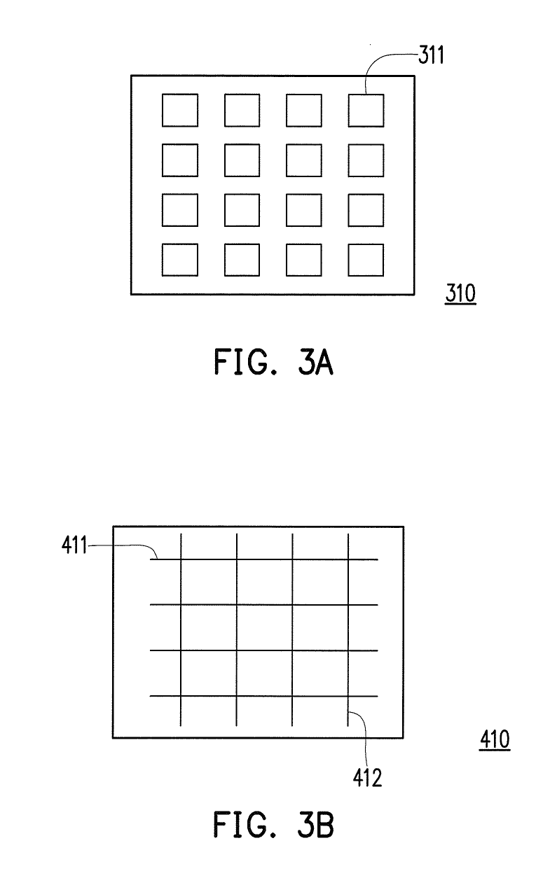

Referring to FIG. 3A, FIG. 3A is a schematic diagram of a biometric sensor according to an embodiment of the invention. In the exemplary embodiment of the invention, the biometric sensor 110 may also be a biometric sensor 310 of FIG. 3A. In the present embodiment, the biometric sensor 310 may include a plurality of biometric sensing pixels 311 arranged in a two-dimensional biometric sensor array. The biometric sensor 310 senses the fingerprint to obtain the biological feature of the fingerprint by the biometric sensing pixels 311. Each of the biometric sensing pixels 311 may be controlled by the control circuit 220, e.g. a scan logic circuit, to sense the fingerprint and respectively generate sensing signals.

Referring to FIG. 3B, FIG. 3B is a schematic diagram of a biometric sensor according to another embodiment of the invention. In the exemplary embodiment of the invention, the biometric sensor 110 may be a biometric sensor 410 of FIG. 3B. The biometric sensor 410 may include a plurality of row traces 411 and a plurality of column traces 412. The intersections of the row traces 411 and the column traces 412 are configured to form a plurality of biometric sensing pixels, and each of the biometric sensing pixels may be controlled by the control circuit 220 to respectively generate sensing signals. Therefore, the biometric sensor 410 may sense the fingerprint to obtain the biological feature of the fingerprint by the biometric sensing pixels thereof. It should be noticed that the structures of the biometric sensors illustrated in FIG. 3A and FIG. 3B are exemplary examples, and the invention is not limited thereto.

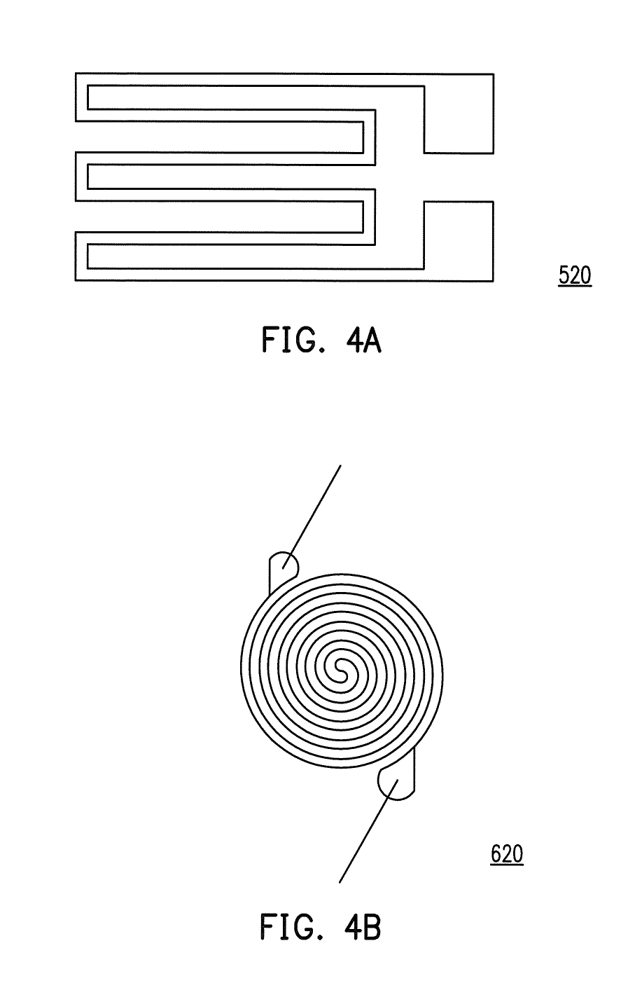

Referring to FIG. 4A, FIG. 4A is a schematic diagram of a resistive force sensor according to an embodiment of the invention. In the exemplary embodiment of the invention, the force sensor 120 may be a force sensor 520 of FIG. 4A. The force sensor 520 may be a compressive strain gauge, and the material of the compressive strain gauge is metal in the present embodiment. To be specific, when an object presses the force sensor 520, the resistance of the compressive strain gauge may be changed based on the deformation of the compressive strain gauge. The object may be a user's finger, and so on. The resistance of the compressive strain gauge is proportional to the deformation of the compressive strain gauge. In other words, the resistance of the compressive strain gauge may be changed based on the compression degrees of the compressive strain gauge.

Referring to FIG. 4B, FIG. 4B is a schematic diagram of a resistive force sensor according to the embodiment of the invention. In the exemplary embodiment of the invention, the force sensor 120 may also be a force sensor 620 of FIG. 4B. The force sensor 620 may be a tensile strain gauge, and the material of the tensile strain gauge is metal. To be specific, when an object presses the force sensor 620, the resistance of the tensile strain gauge is changed based on the deformation of the tensile strain gauge. The object may be a user's finger and so on. The resistance of the tensile strain gauge is proportional to the deformation of the tensile strain gauge. In other words, the resistance of the tensile strain gauge may be changed based on the degree of tension of the tensile strain gauge. It should be noticed that the structures of the resistive force sensor illustrated in FIG. 4A and FIG. 4B are exemplary examples, and the invention is not limited thereto.

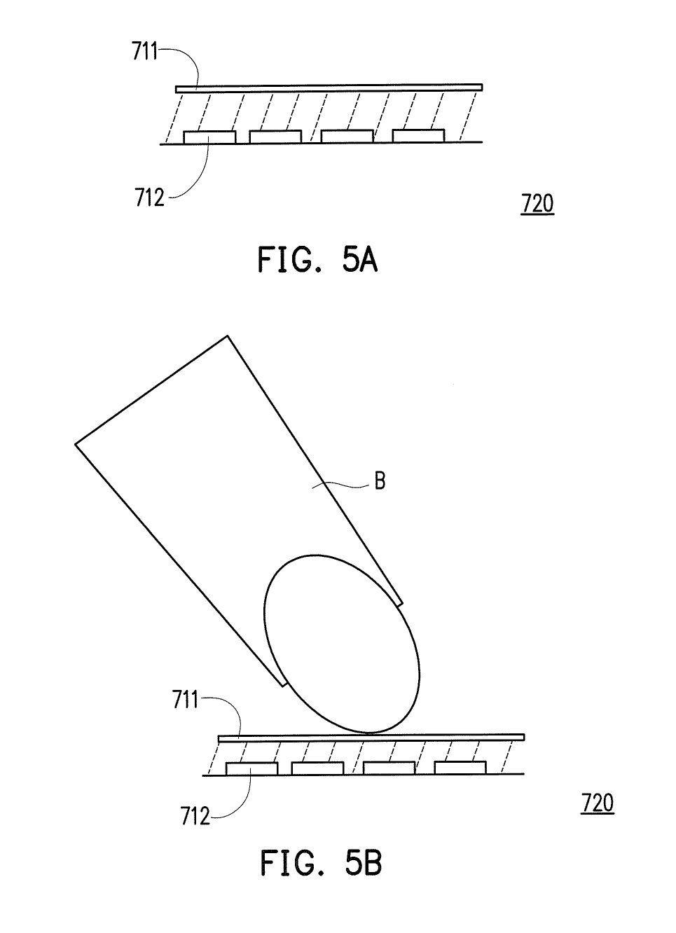

Referring to FIG. 5A and FIG. 5B, FIG. 5A and FIG. 5B are schematic diagrams of a capacitive force sensor according to an embodiment of the invention. In the exemplary embodiment of the invention, the force sensor 120 may also be a force sensor 720 of FIG. 5A and FIG. 5B. The force sensor 720 may be a capacitive force sensor. The capacitive force sensor may include a conductive layer 711 and a plurality of conductive traces 712, and further include a compressible medium between the conductive layer 711 and the plurality of conductive traces 712. To be specific, the distance between the conductive layer 711 and the plurality of conductive traces 712 is changed when an object B presses the force sensor 710. Accordingly, the capacitance value between the conductive layer 711 and the plurality of conductive traces 712 is also changed. The object B may be a user's finger, and so on. Hence, the force value of the fingerprint can be determined by measuring changes in capacitance values. In addition, the method of measuring the capacitance values may be a method of self-capacitance or mutual-capacitance, but the invention is not limited thereto.

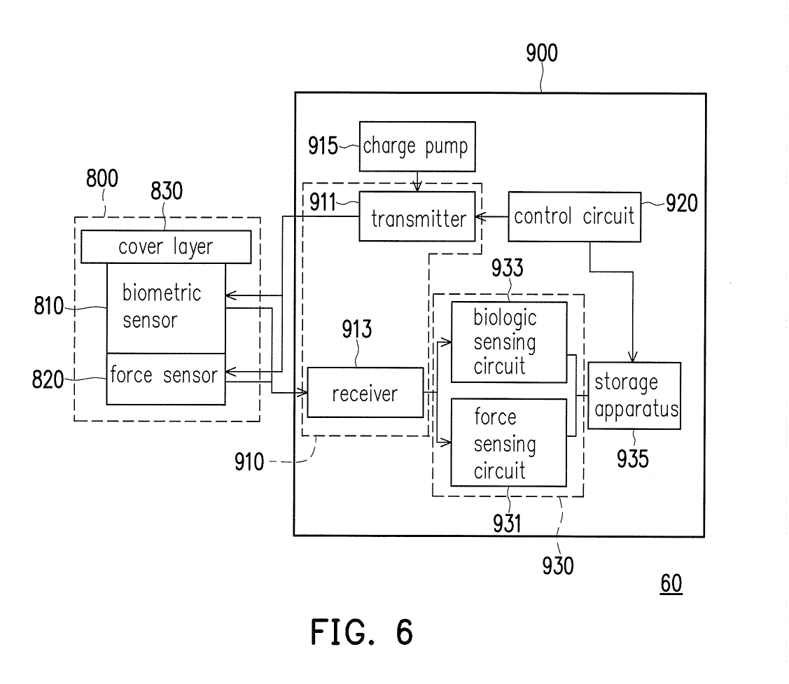

FIG. 6 is a schematic diagram of a fingerprint sensing apparatus according to another embodiment of the invention. In the present embodiment, the fingerprint sensing apparatus 60 includes an integrated sensor device 800 and a fingerprint sensing circuit 900. The integrated sensor device 800 includes a biometric sensor 810, a force sensor 820, and a cover layer 830. The biometric sensor 810 and the force sensor 820 are configured to sense a fingerprint to obtain a biological feature and a force value of the fingerprint. In addition, the fingerprint sensing circuit 900 includes a transceiver circuit 910, a control circuit 920, an integrated sensing circuit 930, and a storage apparatus 935. It should be noticed that the integrated sensor device 800 described in the present embodiment of the invention is sufficiently taught, suggested, and embodied in the embodiments illustrated in FIG. 1 to FIG. 5B, and therefore no further description is provided herein.

In the present embodiment, the transceiver circuit 910 includes a transmitter 911 and a receiver 913. The transmitter 911 and the receiver 913 are respectively configured to receive and transmit the two type of information related to the fingerprint. The transmitter 911 and the receiver 913 are electrically connected to the control circuit 920. The control circuit 920 controls the transmitter 911 and the receiver 913 to receive and transmit the biological feature and the force value during the different periods respectively. In the present embodiment, the control circuit 920 may control the transmitter 911 to respectively provide driving signals to the biometric sensor 810 and the force sensor 820. The driving signals may be a square wave, sine wave, triangle wave and so on. Therefore, the fingerprint sensing circuit 900 may further include a charge pump 915 to provide a voltage level for the transmitter 911, so that the transmitter 911 outputs the driving signals such as square wave, sine wave, triangle wave and so on to the integrated sensor device 800.

In the present embodiment, when the transmitter 911 provides the driving signals to the biometric sensor 810 and the force sensor 820 to sense the fingerprint, the receiver 913 may receive the information including the force value and the biometrical feature of the fingerprint. It should be noticed that the receiver 913 is simultaneously electrically connected to the biometric sensor 810 and the force sensor 820, so as to receive the information from the biometric sensor 810 and the force sensor 820 in a manner of time division.

In the present embodiment, the integrated sensing circuit 930 includes a force sensing circuit 931 and a biologic sensing circuit 933. The force sensing circuit 931 and the biologic sensing circuit 933 are respectively configured to process the signals corresponding to the force value and the biometrical feature of the fingerprint. The storage apparatus 935 is electrically connected to the force sensing circuit 931 and the biologic sensing circuit 933 to store the processed results. The storage apparatus 935 is further electrically connected to the control circuit 920 to provide the processed results to the control circuit 920.

To be specific, the force sensing circuit 931 and the biologic sensing circuit 933 may process the signals from the receiver 913. The signals may include the information corresponding to the force value and the biometrical feature of the fingerprint. Since the receiver 913 is electrically connected to the biometric sensor 810 and the force sensor 820, the receiver 913 may receive the two different types of info nation related to the fingerprint in the manner of time division. The force sensing circuit 931 and the biologic sensing circuit 933 respectively process the corresponding signals according to the type of information. The two different types of information may include the force value and the biometric feature respectively. The force sensing circuit 931 and the biologic sensing circuit 933 may respectively output a processed result. The processed result may respectively include the force value and the biometric feature of the fingerprint. Furthermore, the storage apparatus 935 is configured to store the processed result, and provide the stored information to the control circuit 920. In another embodiment, the fingerprint sensing apparatus 60 may further include a processor circuit (not shown), or be electrically connected to an external processor circuit. The storage apparatus 935 may also electrically connect to the foregoing processor circuit, and provide the stored information to the foregoing processor circuit. The foregoing processor circuit may generate a feedback or a response according to the stored information. It should be noticed that, the fingerprint sensing apparatus 80 may utilize the control circuit 920 or the foregoing processor circuit to determine one of the two different types of information according to the other of the two different types of information.

In addition, in the present embodiment, the fingerprint sensing apparatus 80 may determine one of the biometrical feature and the force value according to the other of the biometrical feature and the force value, and even generate a feedback to the user according to the sensing result of the biologic sensor and the force sensor. The related feature and the operation of fingerprint sensing apparatus 80 described in the present embodiment of the invention is sufficiently taught, suggested, and embodied in the embodiments illustrated in FIG. 1 and FIG. 2, and therefore no further description is provided herein.

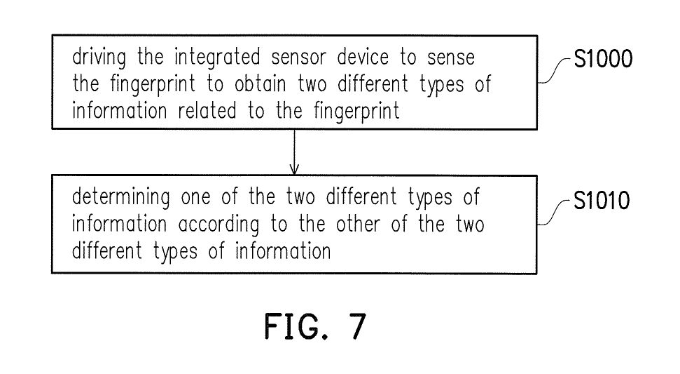

FIG. 7 is a flowchart illustrating steps of a fingerprint sensing method according to an embodiment of the invention. Referring to FIG. 1 and FIG. 7, the fingerprint sensing method is at least adapted to the fingerprint sensing circuit 200 in FIG. 1, but the invention is not limited thereto. The fingerprint sensing method at least includes the following steps. In step S1000, the fingerprint sensing circuit 200 drives the integrated sensor device 100 to sense the fingerprint to obtain two different types of information related to the fingerprint. In step S1010, the fingerprint sensing apparatus 10 determines the one of the two different types of information according to the other of the two different types of information. Besides, the fingerprint sensing method described in the present embodiment of the invention is sufficiently taught, suggested, and embodied in the embodiments illustrated in FIG. 1 to FIG. 6, and therefore no further description is provided herein.

In summary, in the exemplary embodiments of the invention, the fingerprint sensing apparatus may utilize the fingerprint sensing circuit to drive the integrated sensor device having two different types of sensors, and obtain the two different types of information related to the fingerprint. The fingerprint sensing apparatus may determine one of the two different types of information according to the other of the two different types of information. That is to say, the fingerprint sensing circuit respectively processes the content of the two different types of information to obtain the parameter and the feature of the fingerprint, so that the fingerprint sensing apparatus may further generate a feedback or a response to the sensing results of the biologic sensor and the force sensor. Accordingly, the fingerprint sensing apparatus of the exemplary embodiments of the invention may provide a satisfactory user experience.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A fingerprint sensing apparatus, comprising:
an integrated sensor device, comprising at least two sensors, and configured to sense a fingerprint to obtain two different types of information related to the fingerprint; and
a fingerprint sensing circuit, electrically connected to the integrated sensor device, and configured to drive the integrated sensor device to sense the fingerprint,
wherein one of the two different types of information is determined according to the other of the two different types of information.

2. The fingerprint sensing apparatus according to claim 1, wherein the at least two sensors comprise a biometric sensor and a force sensor, and the two different types of information comprise a biological feature and a force value of the fingerprint.

3. The fingerprint sensing apparatus according to claim 2, wherein the biometric sensor senses the fingerprint to obtain the biological feature of the fingerprint by biometric sensing pixels thereof.

4. The fingerprint sensing apparatus according to claim 2, wherein the force sensor senses the fingerprint to obtain the force value of the fingerprint, and the force sensor is selected from one of a capacitive sensor and a resistive sensor.

5. The fingerprint sensing apparatus according to claim 2, wherein the biometric sensor and the force sensor are stacked with each other, and one of the biometric sensor and the force sensor is disposed on the other of the biometric sensor and the force sensor.

6. The fingerprint sensing apparatus according to claim 2, wherein if the force value satisfies a predetermined condition, whether the biological feature is matched with a reference feature is determined.

7. The fingerprint sensing apparatus according to claim 2, wherein if the biological feature is identified, whether the force value satisfies a predetermined condition is determined.

8. The fingerprint sensing apparatus according to claim 2, wherein the fingerprint sensing circuit respectively drives the biometric sensor and the force sensor to sense the fingerprint in a manner of time division.

9. The fingerprint sensing apparatus according to claim 8, wherein the fingerprint sensing circuit comprises a transceiver circuit electrically connected to the biometric sensor and the force sensor, and the transceiver circuit receives or transmits the biological feature and the force value during different periods.

10. The fingerprint sensing apparatus according to claim 9, wherein the fingerprint sensing circuit further comprises a control circuit electrically connected to the transceiver circuit, and the control circuit controls the transceiver circuit to receive or transmit the biological feature and the force value during the different periods.

11. The fingerprint sensing apparatus according to claim 9, wherein the fingerprint sensing circuit further comprises an integrated sensing circuit electrically connected to the transceiver circuit, wherein the integrated sensing circuit comprises at least two sensing circuits configured to respectively process the two different types of information, and stores a processed result to a storage apparatus.

12. A fingerprint sensing circuit, configured to drive an integrated sensor device to sense a fingerprint, and comprising:
a transceiver circuit, electrically connected to the integrated sensor device, and configured to receive or transmit two different types of information related to the fingerprint;
a control circuit, electrically connected to the transceiver circuit, and configured to control the transceiver circuit to receive or transmit the two different types of information during different periods; and
an integrated sensing circuit, electrically connected to the transceiver circuit, and comprising at least two sensing circuits configured to respectively process the two different types of information,
wherein the integrated sensor device comprises at least two sensors configured to sense the fingerprint to obtain the two different types of information, and one of the two different types of information is determined according to the other of the two different types of information.

13. The fingerprint sensing circuit according to claim 12, wherein the at least two sensors comprise a biometric sensor and a force sensor, and the two different types of information comprise a biological feature and a force value of the fingerprint.

14. The fingerprint sensing circuit according to claim 13, wherein the biometric sensor senses the fingerprint to obtain the biological feature of the fingerprint by biometric sensing pixels thereof.

15. The fingerprint sensing circuit according to claim 13, wherein the force sensor senses the fingerprint to obtain the force value of the fingerprint, and the force sensor is selected from one of a capacitive sensor and a resistive sensor.

16. The fingerprint sensing circuit according to claim 13, wherein the biometric sensor and the force sensor are stacked with each other, and one of the biometric sensor and the force sensor is disposed on the other of the biometric sensor and the force sensor.

17. The fingerprint sensing circuit according to claim 13, wherein if the force value satisfies a predetermined condition, whether the biological feature is matched with a reference feature is determined.

18. The fingerprint sensing circuit according to claim 13, wherein if the biological feature is identified, whether the force value satisfies a predetermined condition is determined.

19. A fingerprint sensing method, adapted to drive an integrated sensor device to sense a fingerprint, and the fingerprint sensing method comprising:
driving the integrated sensor device to sense the fingerprint to obtain two different types of information related to the fingerprint, wherein the integrated sensor comprises at least two sensors; and
determining one of the two different types of information according to the other of the two different types of information.

20. The fingerprint sensing method according to claim 19, wherein the at least two sensors comprises a biometric sensor and a force sensor, and the two different types of information comprise a biological feature and a force value of the fingerprint.

21. The fingerprint sensing method according to claim 20, wherein the step of determining one of the two different types of information according to the other of the two different types of information comprises:
if the force value satisfies a predetermined condition, determining whether the biological feature is matched with a reference feature.

22. The fingerprint sensing method according to claim 20, wherein the step of determining one of the two different types of information according to the other of the two different types of information comprises:
if the biological feature is identified, determining whether the force value satisfies a predetermined condition.

23. The fingerprint sensing method according to claim 21, wherein the step of driving the integrated sensor device to sense the fingerprint to obtain two different types of information related to the fingerprint comprises:
respectively driving the biometric sensor and the force sensor to sense the fingerprint in a manner of time division.
